(19) United States
(12) Patent Application Publication
(10) Pub. No.: US 2025/0072463 A1
(43) Pub. Date: Mar. 6, 2025

(54) PLUNGER RETENTION ASSEMBLY FOR A MICRO-PUREE MACHINE

(71) Applicant: SharkNinja Operating LLC, Needham, MA (US)

(72) Inventor: Nathan Lyell, Surrey (GB)

(73) Assignee: SharkNinja Operating LLC, Needham, MA (US)

(21) Appl. No.: 18/611,043

(22) Filed: Mar. 20, 2024

Related U.S. Application Data
(60) Provisional application No. 63/579,599, filed on Aug. 30, 2023.

(51) Int. Cl. A23P 30/20; A23G 9/12; A23G 9/28

(52) U.S. Cl. CPC A23P 30/20; A23G 9/12; A23G 9/281

(57) ABSTRACT

A plunger retention assembly for a micro-puree machine includes a lid coupleable to a bowl. The lid defines a central passage through an interior of the lid. A plunger coupling is extendable through the central passage. A plunger has an attachment portion insertable through the central passage from a bottom surface of the lid. The attachment portion defines a channel for removeably receiving the plunger coupling.

### CROSS-REFERENCED TO RELATED APPLICATIONS

This application claims priority to and benefit of U.S. Provisional Application No. 63/579,599, filed on Aug. 30, 2023, entitled AUTOMATIC BOWL LOCK FOR A MICRO PUREE MACHINE, the contents of which are incorporated herein by reference for all purposes.

### FIELD

The present disclosure relates to a food processing device and, more particularly, to a micro-puree machine with an automatic lock for locking the processing bowl to the machine/a sealable processing bowl.

### BACKGROUND

Domestic kitchen appliances that are intended to make ice creams, gelatos, frozen yogurts, sorbets and the like are known in the art. Typically, a user adds a series of non-frozen ingredients to a mixing bowl, which often has been previously cooled, for example, in a freezer. The ingredients are then churned by a one or more paddles (sometimes referred to as dashers) while a refrigeration mechanism simultaneously freezes the ingredients. These devices have known shortcomings including, but not limited to, the amount of time and effort required by the user to complete the ice cream-making process. Machines of this nature are also impractical for preparing most non-dessert food products.

An alternative type of machine known for making a frozen food product may be referred to as a micro-puree machine. Typically, machines of this nature spin and plunge a blade into a pre-frozen ingredient or combination of ingredients. While able to make frozen desserts like ice creams, gelatos, frozen yogurts, sorbets, and the like, micro-puree machines can also prepare non-dessert types of foods such as non-dessert purees and mousses.

### SUMMARY

The disclosure, in various embodiments, describes illustrative systems, methods, and devices that aid in both completely sealing the mixing bowl during processing while also allowing a nozzle to be opened to dispense the ingredients.

In embodiments, a plunger retention assembly for a micro-puree machine of this disclosure includes a lid coupleable to a bowl. The lid defines a central passage through an interior of the lid. A plunger coupling is extendable through the central passage. A plunger has an attachment portion insertable through the central passage from a bottom surface of the lid. The attachment portion defines a channel for removeably receiving the plunger coupling.

In further embodiments, the lid includes at least one retainer within the interior of the lid. An outer surface of the attachment portion includes at least one engagement feature for engaging the at least one retainer. The at least one retainer is moveable between a first position, in which the at least one retainer engages the engagement feature to retain the plunger in the lid, and a second position, in which the at least one retainer disengages from the engagement feature to allow removal of the plunger from the lid. In embodiments, the at least one retainer is four retainers. In embodiments, the at least one retainer is biased toward the central passage. In embodiments, the lid has a release lever operatively coupled to the at least one retainer to move the at least one retainer between the first position and the second position. In embodiments, the plunger coupling is configured to move with the driven shaft of the micro-puree machine. In embodiments, a cross-sectional shape of the attachment portion is rectangular. In embodiments, the at least one engagement feature is four engagement features. In embodiments, a bottom surface of the lid defines an opening in communication with the central passage. In embodiments, a cross-sectional shape of the opening corresponds to a cross-sectional shape of the attachment portion. In embodiments, the cross-sectional shape of the opening is rectangular. In embodiments, the at least one engagement feature has an upper angled ledge for engaging a lower angled surface of the at least one retainer to urge the at least one retainer away from the central passage when the attachment portion is inserted into the passage. In embodiments, the channel of the attachment portion includes at least one projection for engaging a corresponding slot defined on an outer surface of the plunger coupling. In embodiments, the plunger is locked to the plunger coupling when the at least one projection is rotated into the corresponding slot. In embodiments, the at least one projection is four projections. In embodiments, a diameter of an upper portion the corresponding slot is selected to be wider than a diameter of a lower portion of the corresponding slot such that a shelf is defined between the upper and lower portions. The shelf is configured to prevent disengagement of the at least one projection from the corresponding slot. In embodiments, the plunger and the plunger coupling further include corresponding haptic features for providing haptic input to a user that the plunger is properly installed on the plunger coupling.

Embodiments of a micro-puree machine of this disclosure include a plunger retention assembly. The plunger retention assembly includes a lid coupleable to a bowl. The lid defines a central passage through an interior of the lid. A plunger coupling is extendable through the central passage of the lid. A plunger has an attachment portion insertable through the central passage from a bottom surface of the lid. The attachment portion defines a channel for removeably receiving the plunger coupling.

In further embodiments, the lid includes at least one retainer within the interior of the lid. An outer surface of the attachment portion includes at least one engagement feature for engaging the at least one retainer. The at least one retainer is moveable between a first position, in which the at least one retainer engages the engagement feature to retain the plunger in the lid, and a second position, in which the at least one retainer disengages from the engagement feature to allow removal of the plunger from the lid. In embodiments, the channel of the attachment portion includes at least one projection for engaging a corresponding slot defined on an outer surface of the plunger coupling.

A reading of the following detailed description and a review of the associated drawings will make apparent the advantages of these and other structures. Both the foregoing general description and the following detailed description serve as an explanation only and do not restrict aspects of the disclosure as claimed.

### BRIEF DESCRIPTION OF THE DRAWINGS

Reference to the detailed description, combined with the following figures, will make the disclosure more fully understood, wherein:

FIG. 1A shows an isometric view of a micro-puree machine, according to some embodiments of the disclosure.

FIG. 1B shows the micro-puree machine of FIG. 1A with the bowl assembly disassembled from the housing, according to some embodiments of the disclosure.

FIGS. 1C-1G illustrate embodiments of extrusion assemblies, bowl assemblies, and/or nozzle assemblies of the micro-puree machine of FIG. 1A, according to some embodiments of the disclosure;

FIG. 2A illustrates a portion of another micro-puree machine, according to some embodiments of the disclosure;

FIG. 2B illustrates a reversible bowl assembly that may be coupled to the micro-puree machine of FIG. 2A, according to some embodiments of the disclosure;

FIG. 3A shows another reversible bowl assembly, according to some embodiments of the disclosure.

FIG. 3B shows a blade of the reversible bowl assembly of FIG. 3A, according to some embodiments of the disclosure;

FIG. 3C is a cut-away view of the reversible bowl assembly and first lid of FIGS. 3A and 3B, according to some embodiments of the disclosure;

FIG. 3D shows a detailed view of an embodiment of a plunger coupled to the underside of second lid, according to some embodiments of the disclosure;

FIGS. 4A and 4B illustrate the use of the reversible bowl assembly of FIGS. 3A-3D, according to some embodiments of the disclosure;

FIGS. 5A-5F illustrate another micro-puree machine, according to some embodiments of the disclosure;

FIGS. 6A and 6B illustrate a micro-puree machine with an automatic bowl lock, according to some embodiments of the disclosure;

FIGS. 7A-7J illustrate a plunger retention assembly, according to some embodiments of the disclosure; and

FIGS. 8A-8G illustrate a plunger lockout assembly, according to some embodiments of the disclosure.

### DETAILED DESCRIPTION

In the following description, like components have the same reference numerals, regardless of different illustrated embodiments. To illustrate embodiments clearly and concisely, the drawings may not necessarily reflect appropriate scale and may have certain structures shown in somewhat schematic form. The disclosure may describe and/or illustrate structures in one embodiment, and in the same way or in a similar way in one or more other embodiments, and/or combined with or instead of the structures of the other embodiments.

In the specification and claims, for the purposes of describing and defining the invention, the terms “about” and “substantially” represent the inherent degree of uncertainty attributed to any quantitative comparison, value, measurement, or other representation. The terms “about” and “substantially” moreover represent the degree by which a quantitative representation may vary from a stated reference without resulting in a change in the basic function of the subject matter at issue. Open-ended terms, such as “comprise,” “include,” and/or plural forms of each, include the listed parts and can include additional parts not listed, while terms such as “and/or” include one or more of the listed parts and combinations of the listed parts. Use of the terms “top,” “bottom,” “above,” “below” and the like helps only in the clear description of the disclosure and does not limit the structure, positioning and/or operation of the disclosure in any manner.

Notably, the mechanisms and techniques described herein may be used to configure a machine to process (e.g., micro-puree and perhaps aerate) and extrude ice cream and other frozen ingredients. That is, both the processing and extrusion functions can be performed by a single machine. In such a machine, a same shaft may be used to drive a blade to process the frozen ingredients in a bowl (i.e., a container) and to drive a plunger to extrude the processed ingredients from the bowl. Further, such a machine may include a user interface enabling a user to control the timing of the performance of each function. In some implementations of such a machine, a first shaft may be used to drive processing and a second shaft may be used to drive extrusion, and such implementations may be considered to have a first sub-system or module for processing and a second sub-system or module for extrusion.

In some embodiments, a single lid may be provided (e.g., on an open end of the bowl) that houses (or is coupled to) a blade for processing ingredients, and that also houses (or is coupled to) a plunger for extruding the processed ingredients. In such embodiments, a single shaft driven by one or more motors (e.g., one motor for driving rotation of blade; the other motor for driving linear movement of the driven shaft along its axis) may drive both the processing that uses the blade and the extrusion that uses the plunger, as described in more detail elsewhere herein, and an end of the bowl opposite the lid may include an opening for extrusion of the processed ingredients from the bowl.

In other embodiments, to enable the performance of both functions, the user may flip the processing bowl from a first arrangement, in which the driven shaft engages a blade at a first end of the processing bowl (e.g., the blade housed in or coupled to a first lid at a first open end of the processing bowl), to a second arrangement, in which the driven shaft engages a plunger at a second end of the processing bowl (e.g., the plunger housed in or coupled to a second lid at an open second end of the processing bowl), as described in more detail herein. In such embodiments, the first lid also may include an opening for extruding the ingredients from the bowl during extrusion using the plunger in the second arrangement. Further, in such embodiments, a single shaft driven by one or more motors may drive both the processing by use of the blade and the extrusion by use of the plunger, as described in more detail elsewhere herein.

In other embodiments, to enable the performance of both functions, the user may replace a first lid (e.g., housing or coupled to a blade) for processing from an open end of the processing bowl with a second lid (e.g., housing or coupled to a plunger) for extruding, as described in more detail elsewhere herein. In such embodiments, a single shaft driven by one or more motors may drive both the processing by use of the blade and the extrusion by use of the plunger, or alternatively, a separate shaft may be used for extruding, in which such separate shaft drives the plunger, as described in more detail elsewhere herein.

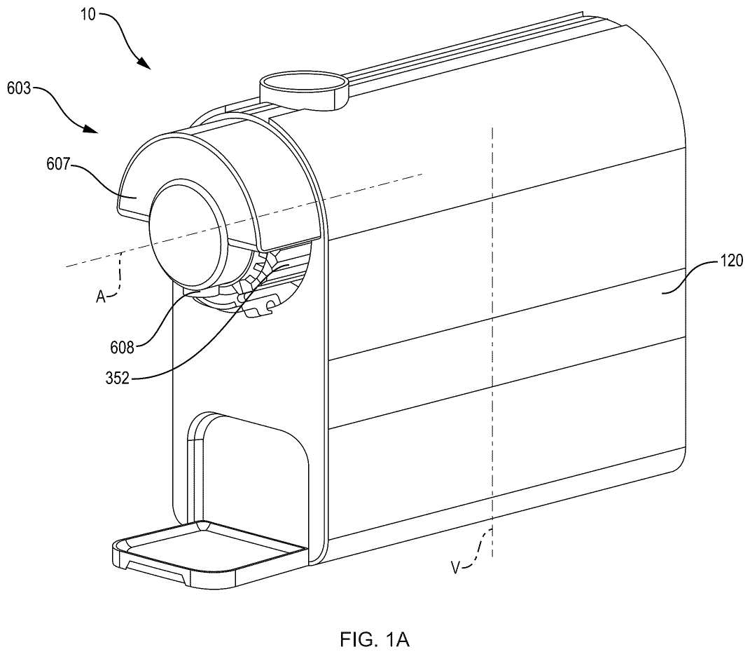

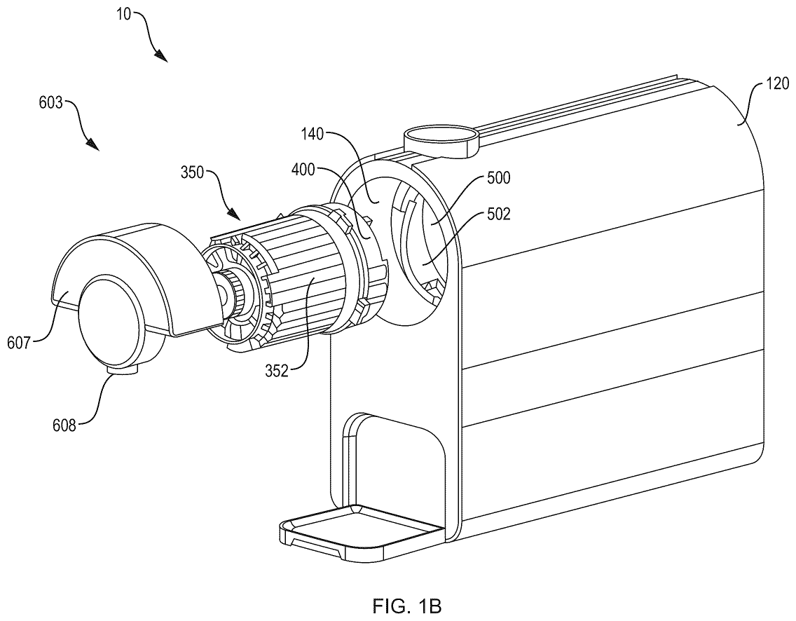

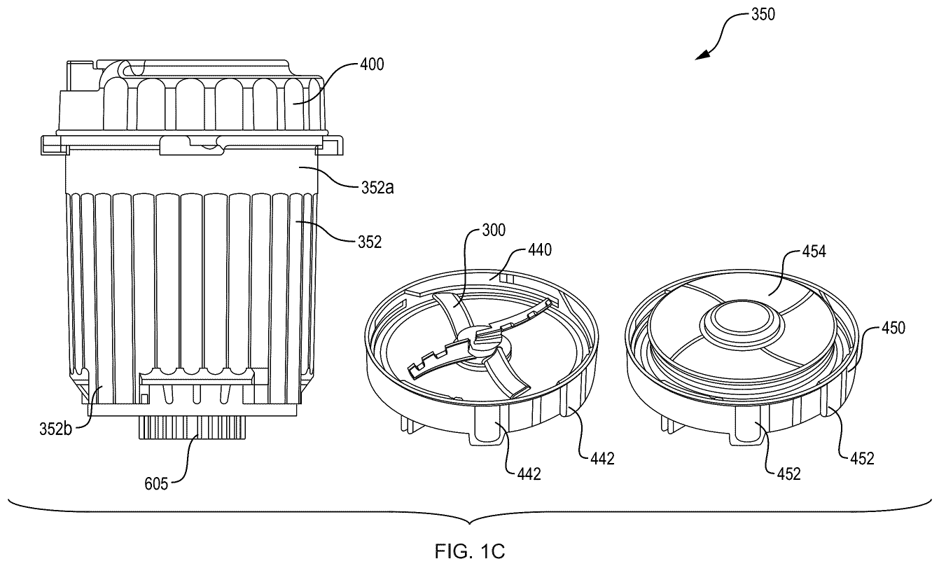

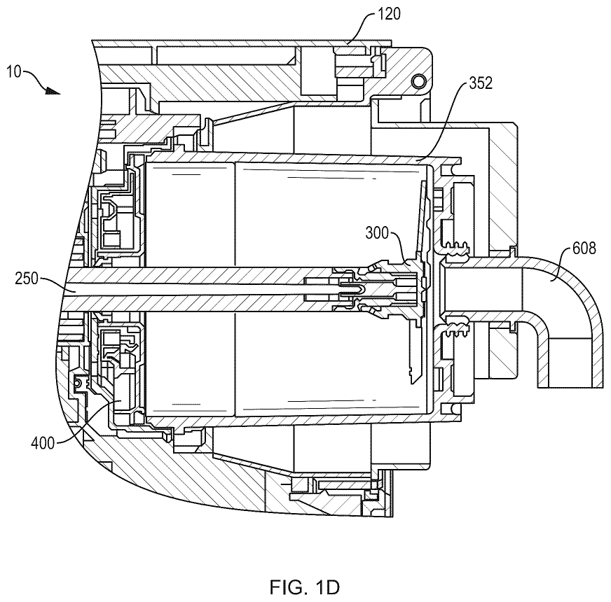

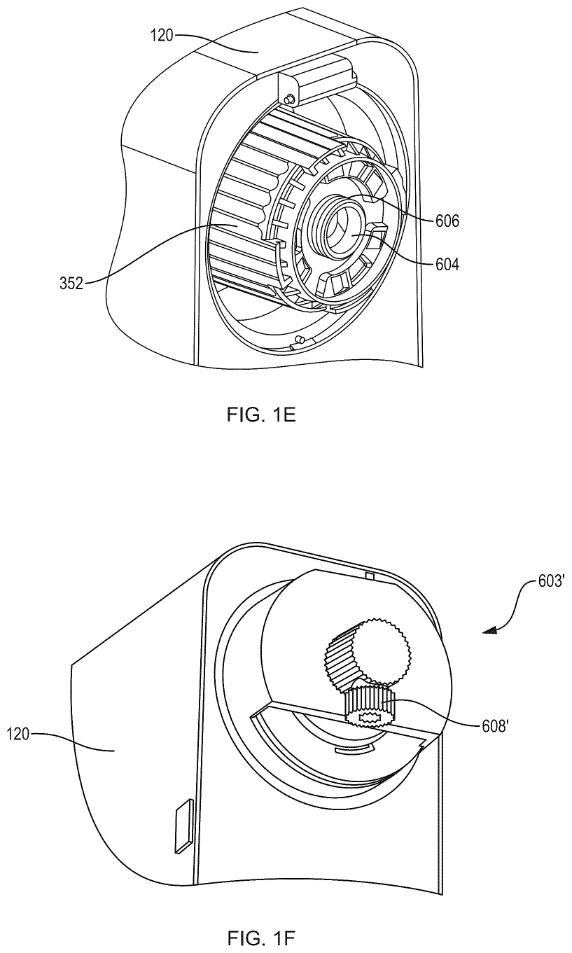

FIG. 1A shows an isometric view of a micro-puree machine 10 according, to some embodiments of the disclosure. FIG. 1B shows the micro-puree machine 10 of FIG. 1A with the bowl assembly 350 disassembled from the housing 120 according to some embodiments of the disclosure. FIGS. 1C-1G illustrate embodiments of the extrusion assemblies, bowl assemblies, and/or nozzle assemblies, according to some embodiments of the disclosure.

The micro-puree machine 10 may include a housing 120, which may include a user interface (not shown) for receiving user inputs to control the micro-puree machine 10 and/or display information. The micro-puree machine 10 also may include a bowl assembly 350 and a nozzle assembly 603. The combination of a bowl assembly 350, which may include a lid 400 configured for extruding, and a nozzle assembly 603 may be referred to herein as an extrusion assembly. The nozzle assembly 603 may include a nozzle housing 607 and a nozzle 608.

The bowl assembly 350 may include a bowl 352 configured to contain one or more processed ingredients, ingredients to be processed, or ingredients being processed. A user may couple the bowl assembly 350 to the housing 120 by rotating the bowl assembly 350 relative to the housing 120 (e.g., using screwing threads or a bayonet connection), or by another coupling mechanism and/or technique. The bowl assembly 350 may be assembled to the housing 120 such that a central axis A of the bowl assembly 350 extends perpendicular to a vertical axis V of the housing 120, as shown. However, the disclosure contemplates that the bowl assembly 350 may be assembled to the housing 120 such that the central axis A extends at an angle between 0 and 90° to the vertical axis, for example, as described in U.S. Pat. No. 11,759,057 to SharkNinja Operating, LLC, the entire contents of which are hereby incorporated by reference (the '057 patent), or such that the central axis of the bowl assembly 350 extends parallel to the vertical axis V, for example, as described in U.S. Pat. No. 11,871,765 to SharkNinja Operating, LLC, the entire contents of which are hereby incorporated by reference (the '756 patent). In embodiments, the bowl 352 of the bowl assembly 350 can be manufactured from a disposable material to enhance the convenience of using the micro-puree machine 10. Further, the bowl 352 can be sold as a stand-alone item and can also be prefilled with ingredients to be processed during use of the micro-puree machine 10.

As shown in FIG. 1B, the housing 120 may including a coupling 500 disposed within an opening 140 of the housing 120. An inner surface 502 of the coupling 500 may comprise locating and locking elements for positioning and connecting the bowl assembly 350 to the coupling 500 in two different configurations, as described elsewhere herein. The micro-puree machine 10 may further include a nozzle 608 couplable to the bowl assembly 350 for extruding processed ingredients from the bowl assembly 350. The nozzle 608 may be arranged such that the ingredients are extruded in a vertically downward direction such that a user can place an ice cream cone, cup, bowl, or other edible or non-edible receptacle underneath the nozzle to receive extruded ingredients. The disclosure also contemplates that multiple nozzle shapes may be provided to allow for user customizability. For example, multiple nozzles may be included on a rotatable dial that allows the user to select the desired nozzle shape. In further embodiments, the extrude function may be integrated into a program on the user interface with a predetermined translation speed/flow rate.

As shown in FIG. 1C, the first end 352a of the bowl 352 may be configured to couple to both a first lid 440 and the second lid 450. The first lid 440 may include a blade 300 for processing ingredients, for example, a blade as described in the '765 patent. When the lid 440 is coupled to the bowl 352 (e.g., via reciprocal threading on the bowl and lid), the bowl assembly 350 may be considered to be in a processing configuration and may be coupled to the housing via coupling 500. The lid 440 may have locating and locking elements 442 on its exterior sidewall configured to couple to the locating and locking elements on the inner surface 502 of the coupling 500. The second lid 450 may include a plunger 454 for extruding ingredients. The plunger 454 may furthermore include a flexible seal around its perimeter to ensure contact (e.g., maximum contact) with the sidewall of the bowl 352 to allow for optimal (e.g., maximum) extrusion yield. When the lid 450 is coupled to the bowl 352 (e.g., via reciprocal threading on the bowl and lid), the bowl assembly 350 may be considered to be in an extruding configuration and may be coupled to the housing via coupling 500. The lid 450 may have locating and locking elements 452 on its exterior sidewall configured to couple to the locating and locking elements on the inner surface 502 of the coupling 500.

The second end 352b of the bowl 352 may include a centrally located opening 604, or an opening that is not centrally located, including a coupling collar 606. The coupling collar 606 may include threading or other types of coupling features, for example, slots or cams, e.g., for bayoneting. The opening 604 may be enclosed by a cap 605, for example, during processing, which cap may be removed during extruding. The cap 605 may include interior threading (not shown) or other coupling features that allow it to couple to the coupling collar 606. The opening 604 may further be in fluid communication with a nozzle 608. For example, the opening 604 may be in fluid communication with a nozzle through a conduit (e.g., plastic tubing) that extends from the opening 604 to the nozzle 608, e.g., within nozzle assembly 603. In embodiments, such a conduit may include one or more sections connected by joints (e.g., an elbow joint) to translate the direction (e.g., horizontal) of extrusion from opening 604 to a direction (e.g., vertically downward) of extrusion from the nozzle 608.

As shown in FIG. 1D, the user may attach the first lid 440 to the bowl 352 and couple the bowl assembly 350 to the micro-puree machine 10 using the coupling features described herein. The lid 440 may be configured (e.g., as described in the '765 patent) such that, when the lid 440 is coupling to the housing 120, the blade 300 engages a driven shaft 250 and disengages the lid 440. Through use of a user interface (e.g., as described in the '057 patent), the user may activate a program that controls the blade 300 to rotate and move (e.g., descend or move horizontally or at an angle) into the ingredients in the bowl 352 to process (e.g., micro-puree) them. It should be appreciated that in some embodiments, as shown in FIG. 1D, the nozzle assembly 603 or one or more components thereof (e.g., nozzle 608) may be coupled to the second end 352b of the bowl 350 (and perhaps to the housing) even when extrusion is not being performed, e.g., during processing. In such embodiments, the opening 604 may be closed, for example, using cap 605 or by other means. FIG. 1E is a bottom view of the bowl assembly 350 while coupled to the housing, in which the opening 604 is not covered. In actual use, the opening 604 may be closed, e.g., by cap 605, during processing, or open and coupled to the nozzle assembly 603 during extrusion.

After processing the ingredients in the bowl 352, the user then may remove the bowl assembly 350 from the micro-puree machine 10, remove the first lid 440 from first end 352a, replace it with lid 450 on the first end 352a, couple the nozzle assembly to the second end 352b of the bowl assembly 350 if not already attached, couple the bowl assembly 350 to the housing 120, and initiate extrusion via the user interface. During extrusion, the driven shaft drives the plunger 602 from the first end 352a of the bowl 352 to the second end 352b of the bowl, forcing the processed ingredients to extrude the processed ingredients through the opening 604 and through the nozzle 608.

FIG. 1F illustrates another embodiment of a nozzle assembly 603′, including nozzle 608′, which may be used to extrude processed ingredients, for example, using mechanisms and techniques described herein.

FIG. 1G illustrates another bowl assembly 350′ including the extrusion assembly 600 according to some embodiments of the disclosure. As shown in FIG. 1G, the bowl assembly 350′ may include a nozzle 608′ that is integrated with the bottom edge of the bowl 352′, for example, on the sidewall of the bowl 352′ proximate to a second end 352b′ or extending past the second end 352b′. In embodiments, the bowl assembly 350′ may be configured to be installed to the coupling 500 such that the nozzle 608′ faces vertically downwards when the bowl 352′ is properly installed. During extrusion, the movement of the plunger (e.g., plunger 454) will force the processed ingredients through the nozzle 608′. The nozzle 608′ may be selectively located on the bowl 352′ to optimize the amount of processed ingredients that can be extruded, thus minimizing the amount of yield loss after extrusion. For example, the nozzle 608′ may be located near the bottom edge of the bowl 352′, as shown in FIG. 1G. However, the disclosure contemplates that the nozzle 608′ may alternatively be located at a different longitudinal and/or radial position on the bowl 352′. Bowl assembly 350′ and/or bowl 352′ maybe be the same or different than bowl assembly 350 and/or bowl 352, respectively.

Advantageously, the micro-puree machine 10 may include a sensor (not shown) that recognizes which lid is installed into the machine 10 to restrict certain programs based on the lid functions, which may prevent user error when operating the machine 10. For example, the micro-puree machine may only activate the blade 300 when the sensor detects that the bowl 352 is installed in the first configuration in which lid 440 is coupled to bowl 350 and may only activate the plunger 454 when the sensor detects that the bowl 352 is installed in the second configuration in which lid 450 is coupled to bowl 350. For example, each of lids 440 and 450 may include distinctive physical and/or electromagnetic features, e.g., as part of locating and locking elements 442 and 452, respectively, for which coupling 500 or other elements of the micro-puree machine 10 may be configured to detect and distinguish lid 440 from lid 450.

The housing 120 may house one or more motors and a transmission system (e.g., including gearing) that drive a driven shaft (e.g., driven shaft 250) for engaging the blade 300 and/or plunger 454 when the bowl assembly 350 (coupled to lid 440 or 450, respectively) is coupled to the housing for processing or extruding, respectively, for example, as described in the '765 patent or U.S. Pat. No. 11,882,965 to SharkNinja Operating, LLC (the '965 patent), the entire contents of which are hereby incorporated by reference. For example, the one or more motors may include a first motor for driving rotation of the driven shaft 250 via the transmission, which may be used to drive the rotation of the blade 300 during processing, and, if desired (but not necessary) rotating the plunger 454 during extrusion. A second motor may be configured to move the position of the driven shaft 250, via the transmission, along its axis (e.g., back and forth; or up and down), which may be used to drive the back-and-forth movement of the blade 300 into and out of the bowl 350 during processing, and to move the plunger 454 into and out of the bowl 350 during extrusion. In embodiments, the micro-puree machine 10 may include gearboxes (e.g., high ratio gearboxes) and reinforced internals (not shown) to allow an extrusion assembly as described herein to withstand high forces and extrude thick outputs from the nozzle 608.

In some embodiments of the disclosure, a reversible bowl assembly may be used, which does not require that a lid be removed between processing and extruding. For example, the reversible bowl assembly may include: a first lid coupled at one end including a blade for processing and an opening for extruding; and a second lid at the other end including a plunger for extruding. Examples of such embodiments will now be described.

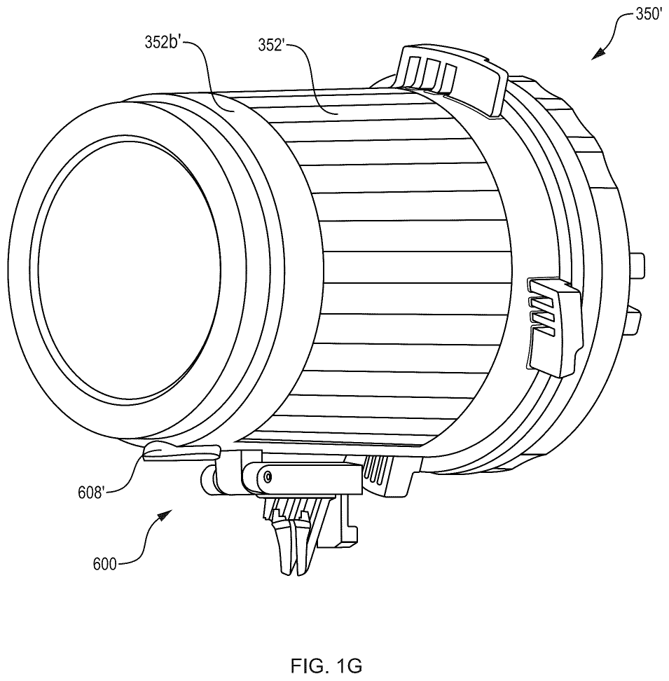

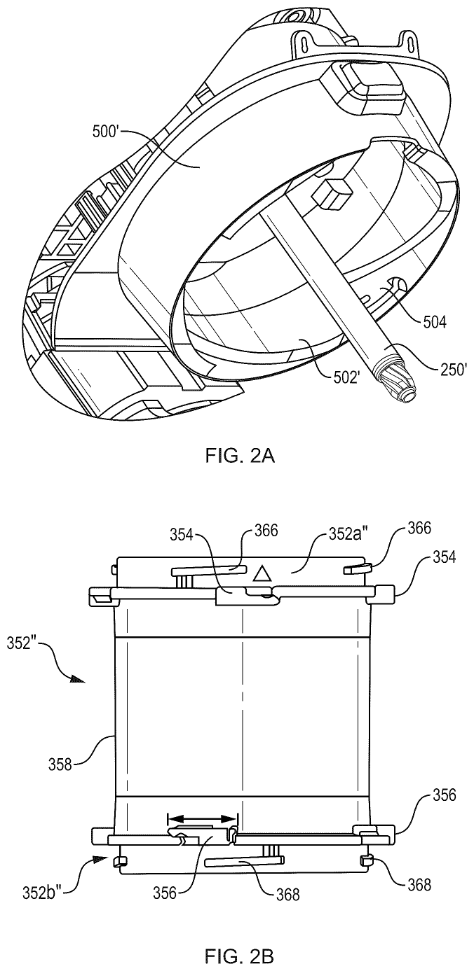

FIG. 2A illustrates an embodiment of a portion of a micro-puree machine including a coupling 500′ for coupling to a bowl assembly, for example, a reversible bowl assembly, in accordance with some embodiments of the disclosure. FIG. 2B illustrates an embodiment of a reversible bowl 352″ that may be coupled to coupling 500′. The bowl 352″ may include any of a variety of external surfaces. For example, embodiments of the bowl may have a ribbed or corrugated surface (e.g., like bowl 352 or 352′), or a smooth surface (e.g., bowl 352″). Similarly, bowls 352 and 352″ may have any variety of surfaces, including smooth surfaces.

As shown in FIG. 2A, the driven shaft 250 of the micro-puree machine 10 may extend from the housing 120 into an interior of the coupling 500′ and optionally all the way through the interior of the coupling 500′. The inner surface 502′ of the coupling 500′ may comprise one or more slots 504 sized and shaped to receive at least one projection 354 on an outer surface of a first open end 352a″ of the bowl 352″. In embodiments, both the first end 352a″ and the second end 352b″ of the bowl 352″ may be open—that is, both the first end 352a″ and the second end 352b″ may not have a top or bottom wall and/or a lid. However, the disclosure is not so limited, and one or both ends 352a″, 352b″ of the bowl 352″ may be closed with a wall or a lid. In embodiments, the at least one projection 354 on the bowl 352″ may be four projections 354 spaced 90 degrees apart about an outer surface of the first end 352a″ of the bowl 352″. However, the disclosure contemplates more or fewer than four projections 354. In a first configuration of the reversible bowl assembly 350″, the user may rotate the bowl 352″ relative to the coupling 500′ such that the projections 354 are rotated into the slots 504, coupling (e.g., locking) the bowl 352″ and the coupling 500′ together.

The slots 504 also may be sized and shaped to receive at least one projection 356 on an outer surface of a second open end 352b″ of the bowl 352″. In embodiments, the at least one projection 356 may be four projections 356 spaced 90 degrees apart about an outer surface of the second end 352b″ of the bowl 352″. However, the disclosure contemplates more or fewer than four projections 356. In a second configuration of the reversible bowl assembly 350″, the user may rotate the bowl 352″ relative to the coupling 500′ such that the projections 356 are rotated into the slots 504, coupling (e.g., locking) the bowl 352″ and the coupling 500′ together. The first end 352a″ of the bowl 352″ may further comprise threads 366 for coupling to a first lid, while the second end 352b″ of the bowl 352″ may comprise threads 368 for coupling to a second lid, as further described elsewhere herein.

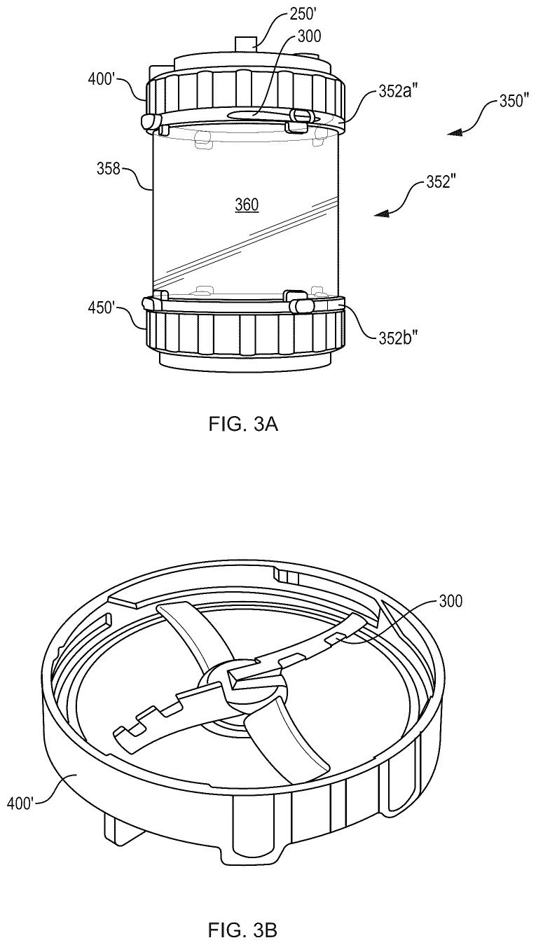

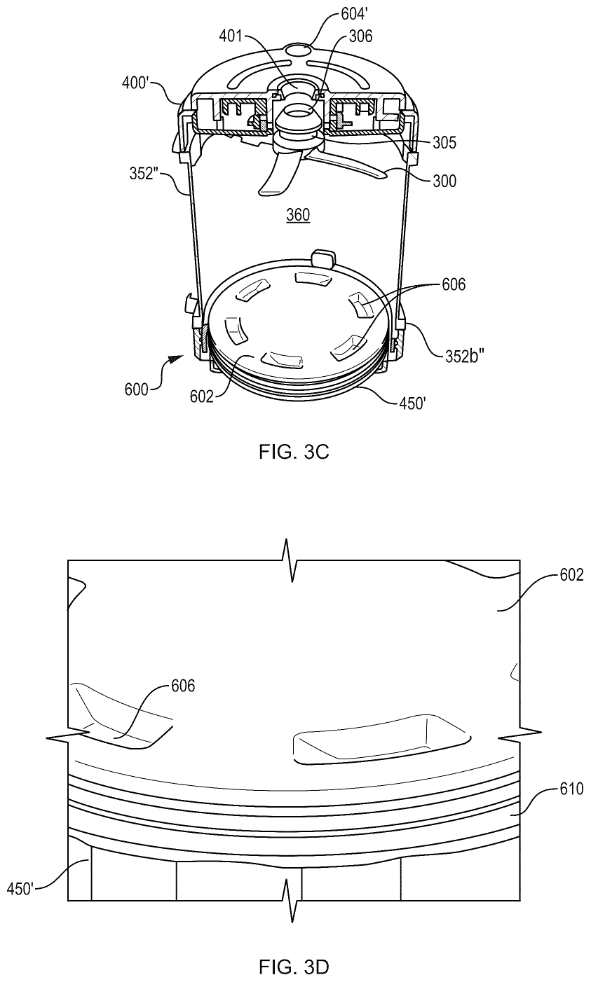

FIG. 3A shows an embodiment of the reversible bowl assembly 350″, assembled according to some embodiments of the disclosure. As shown in FIG. 3A, the bowl 352″ may have an oblong shape and include a cylindrical sidewall 358 defining an interior volume 360 of the bowl 352″. The sidewall 358 may extend between the first open end 352a″ of the bowl 352″ and the second open end 352b″ opposite the first open end 352a″. Embodiments of the sidewall 358 may have various configurations. For example, a cross-section of the sidewall may be circular or polygonal. In addition, a diameter of the sidewall may vary between the first open end 352a″ and the second open end 352b″ (e.g., may be tapered). The first open end 352a″ and the second open end 352b″ may communicate with the interior volume 360 of the bowl 352″. The assembly 350″ may further include a first lid 400′ removably couplable to the first open end 352a″ of the bowl 352″. The first lid 400′ may define an opening 401 (FIG. 3C) configured to couple to a blade 300 for mixing ingredients within the bowl 352″. When the bowl 352″ is installed to the coupling 500′ in the first configuration, the blade 300 may engage with the driven shaft 250′ to rotate and plunge the blade 300 within the ingredients. FIG. 3B shows an embodiment of the blade 300 coupled to the underside of first lid 400′. Some non-limiting examples of the blade 300 are shown in the '765 patent.

FIG. 3C is a cut-away view of the reversible bowl assembly 350″ and the first lid 400′, according to some embodiments of the disclosure, whereas blade 300 and a second lid 450′ are not shown in cut-away form. As shown in FIG. 3C, the blade 300 may include a central support hub 305 including a central opening 306 for engaging the driven shaft 250. In embodiments, the second lid 450′ may removably couple to the second open end 352b″ of the bowl 352″. The second lid 450′ may include, or be coupled to, a plunger 602 for pushing the ingredients in the bowl 352″ toward an opening 604′ in first lid 400′. The plunger 602, alone or in combination with other components (e.g., the second lid 450′, the bowl 352″, or the nozzle 608), may constitute an extrusion assembly 600 for extruding processed ingredients from the bowl 352″. The opening 604′ in the first lid 400′ may further be in fluid communication with a nozzle (e.g. nozzle 608). For example, the opening 604′ may be in fluid communication with a nozzle through a conduit (e.g., plastic tubing) that extends from the opening 604′ to the nozzle. In embodiments, such a conduit may include one or more sections connected by joints (e.g., an elbow joint) to translate the direction (e.g., horizontal) of extrusion from opening 604′ to a direction (e.g., vertically downward) of extrusion from the nozzle.

The plunger 602 may be couplable to the driven shaft 250′ of the micro-puree machine when the bowl assembly 350″ is in the second configuration and the bowl 352″ is installed to the coupling 500′. A surface of the plunger 602 facing the interior volume 360 may include a one or more (e.g., a plurality of) indentations 606. The indentations 606 may prevent frozen ingredients from rotational movement within the bowl 352″ during processing by the blade 300. The plunger 602 may furthermore include a flexible seal 610 around its perimeter to ensure contact (e.g., maximum contact) with the sidewall 358 of the bowl 352″ to allow for optimal (e.g., maximum) extrusion yield.

The micro-puree machine of the embodiments described in relation to FIGS. 2A, 2B, 3A-3D, 4A and 4B may include one or more motors and a transmission system (e.g., including gearing) that drive a driven shaft (e.g., driven shaft 250′) for engaging the blade 300 and/or plunger 602 when the bowl assembly 350″ (coupled to lid 400′ or 450′, respectively) is coupled to the housing for processing or extruding, for example, as described in the '765 patent or the '965 patent; and may include gearboxes (e.g., high ratio gearboxes) and reinforced internals (not shown) to allow the extrusion assembly 600 to withstand high forces and extrude thick outputs from a nozzle.

FIG. 3D shows a detailed view of an embodiment of the plunger 602 coupled to the underside of second lid 450′. In embodiments, the bowl assembly 350″ may be configured such that only the first lid 400′ can couple to the first open end 352a″ of the bowl 352″ and only the second lid 450′ can couple to the second open end 352b″ of the bowl 352″. For example, a configuration of the threads 366 may be different from a configuration of the threads 368 (FIG. 3B) to prevent the user from attaching the wrong lid to the wrong side of the bowl 352″. The bowl 352″ may further include clear indicators (colors, icons, etc.) that would signal to the user which lid goes on which side of the bowl 352″.

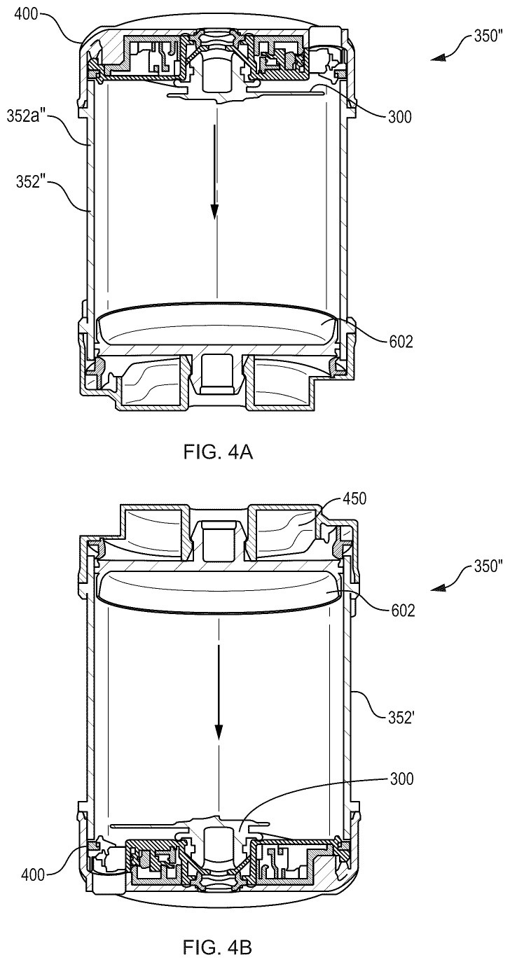

FIGS. 4A and 4B illustrate the use of the reversible bowl assembly 350″ according to some embodiments of the disclosure. As shown in FIG. 4A, a user may first install the bowl assembly 350″ to the micro-puree machine 10 in the first configuration such that the first end 352a″ of the bowl 352″ is secured to the coupling 500′. The user then may select a program at the user interface depending on the desired output (for example, soft serve ice cream, light ice cream, sorbet, gelato, etc.) to spin and plunge the blade 300 into the ingredients in the bowl 352″. For example, the blade 300 may descend into the ingredients and then ascend from the ingredients at one or more predefined rates, while rotating at one or more predefined rates. As shown in FIG. 4B, the user then may then remove the bowl assembly 350″ from the coupling 500′, reverse the orientation of the bowl assembly 350″ (i.e., flip the bowl assembly 350″) and reinstall the second end 352b″ of the bowl 352″ to the coupling 500′ in the second configuration. The user then may select a desired program at the user interface to descend the plunger 602 to extrude the ingredients out through the opening 604′ in the first lid 400′. For example, the plunger 602 may descend into the ingredients to extrude the ingredients out through the opening 604′ and then ascend from the opening 604′ after the extrusion is complete.

While embodiments of the disclosure including performing processing and extrusion using a same driven shaft, in some embodiments, processing and extrusion are performed on different shafts, as will now be described.

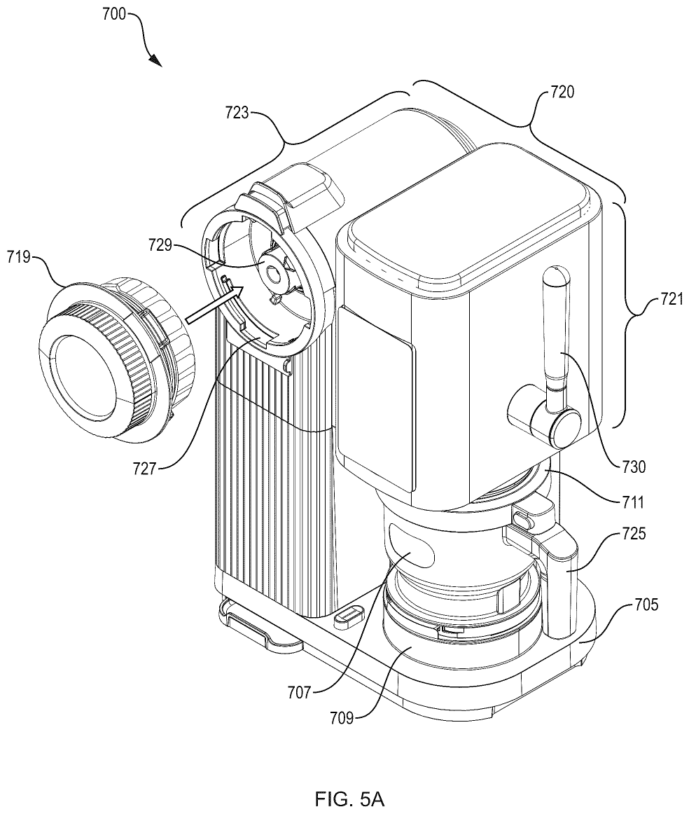

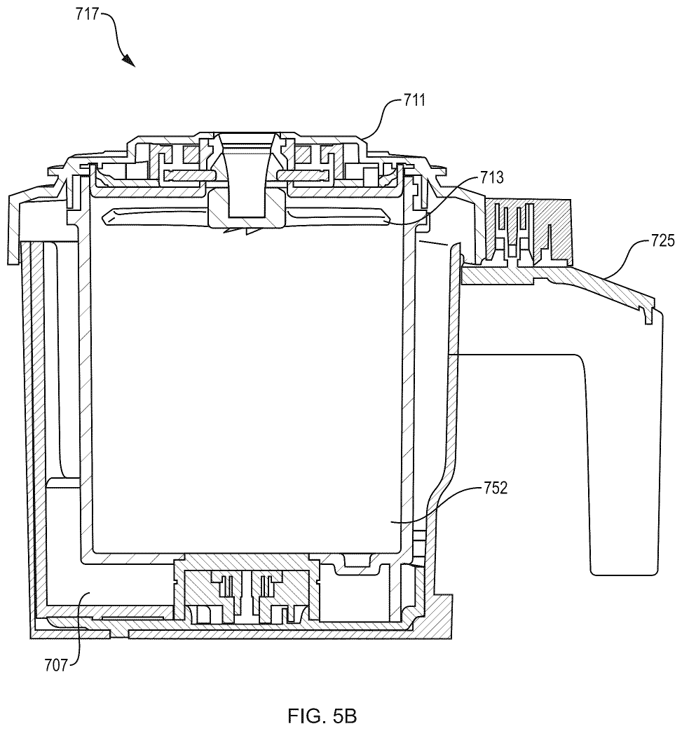

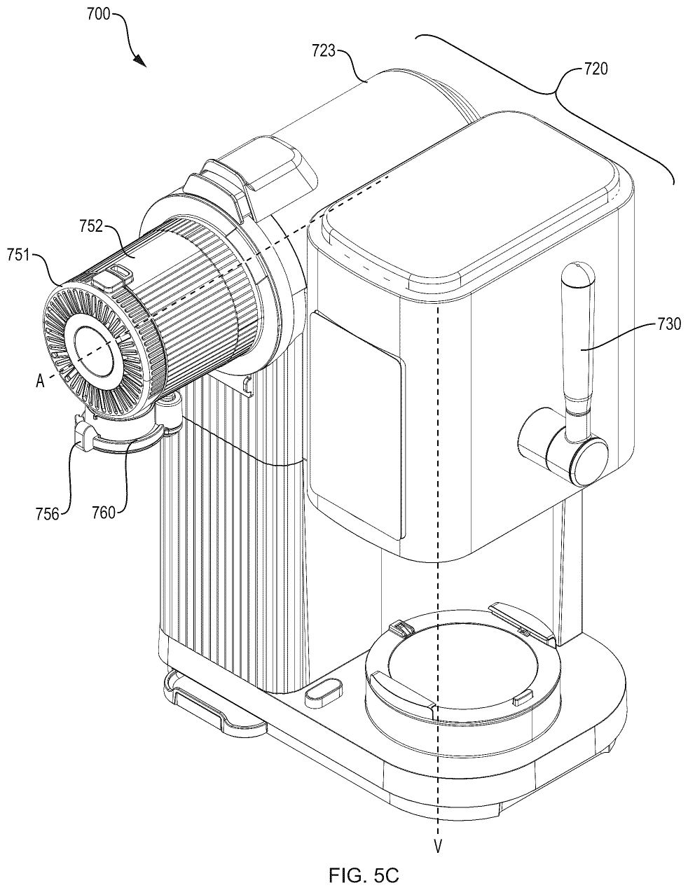

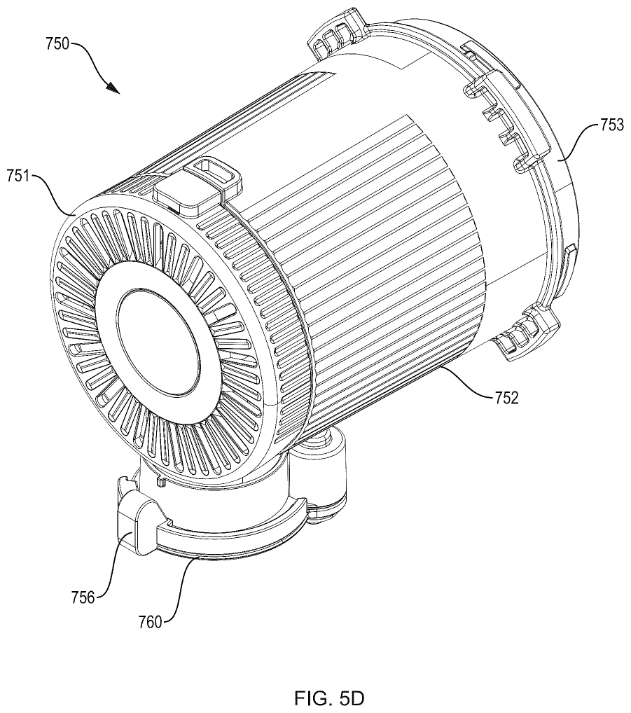

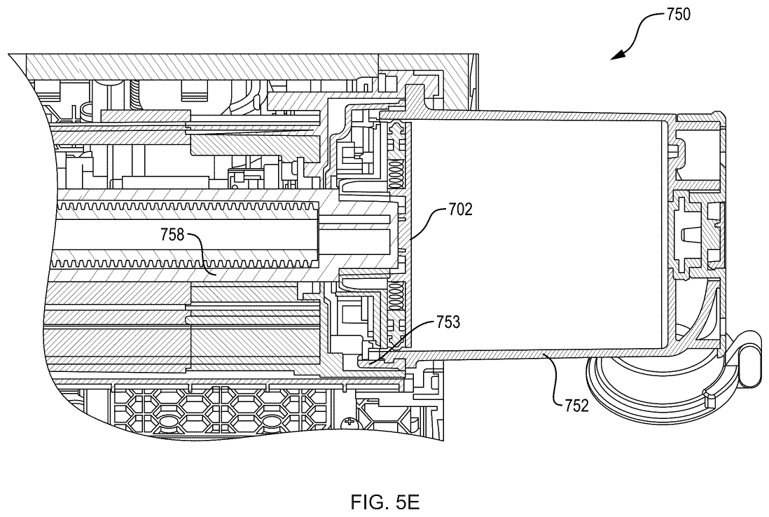

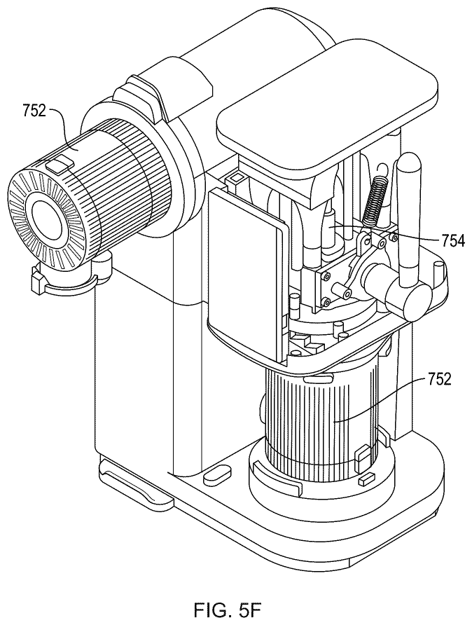

FIGS. 5A-5F illustrate another micro-puree machine 700, according to some embodiments of the disclosure. FIGS. 5A and 5B illustrate an embodiment of micro-puree machine 700 in a first configuration for processing (e.g., micro-pureeing), which may be referred to herein as a processing configuration. FIGS. 5C-5E illustrate an embodiment of micro-puree machine 700 in a first configuration for extruding, which may be referred to herein as an extruding or extrusion configuration. FIG. 5E illustrates an embodiment of micro-puree machine 700 in both processing and extruding configurations merely for illustrative purposes, as in some embodiments, the micro-puree machine 700 is not configured to perform processing and extruding concurrently.

As shown in FIGS. 5A and 5B, the micro-puree machine 700 may include a base 705 and a housing 720. The housing 720 may include a user interface (not shown) for receiving user inputs to control the micro-puree machine 700 and/or display information. In some embodiments, the micro-puree machine includes a processing sub-module 721 including one or more components configured to process ingredients in a bowl 752 (e.g., bowl 352 or a variation thereof) and an extruding sub-module 723 including one or more components configured to extrude processed ingredients from the bowl 752. In a processing configuration, the bowl 752 may be coupled to the interior of an outer bowl 707 that is mounted on a processing platform 709 mounted to the base 705. The bowl 752 may be coupled to a lid 711 (e.g., lid 440 or a variation thereof) that houses a blade 713 (e.g., blade 300 or a variation thereof). The bowl 752 may include a nozzle control assembly 751 (e.g., a dial) that enables a user to control an opening or closing of a nozzle 760, a nozzle 760, and a hinged stopper or plug 756 that can be used by a user to selectively cover the nozzle 760, or the nozzle control assembly 751. In some embodiments, the nozzle control assembly 751, the nozzle 760, and the stopper 756 may be removably attachable to the bowl 752. Using the handle 725, a user may rotate and elevate the processing bowl assembly 717 into a processing position in which the blade 713 engages with a driven shaft 754, the lid 711 couples to the micro-puree machine 700, and the blade 713 is released from the lid 711 so that the driven shaft 754 can drive the shaft 754, for example, as described in the '765 patent. By engaging the user interface (or via a remote interface wirelessly connected to a wireless interface within housing 720), the user may initiate processing of the ingredients in the bowl 752. In a processing configuration, extruding sub-module 723 may remain idle, and a cap or plug 719 may be coupled to a coupling 727, covering an interface 729 with driven shaft 758. The coupling 727 (e.g., coupling 500) also may serve as a coupling between the bowl assembly 750 (e.g., the lid 753 of the bowl assembly 750) and the micro-puree machine 700. After the processing of the ingredients, the processing bowl assembly 717 may be decoupled from the micro-puree machine 710 (e.g., from the processing sub-module 721), and de-mounted from the platform 709. The lid 711 may be removed from the outer bowl 707, and the bowl 752 may be removed from the outer bowl 707.

As shown in FIGS. 5C-5E, a lid 753 then may be mounted to the bowl 752, and the bowl 752 then may be coupled to the micro-processing machine 710 (e.g., to the extruding sub-module 723) in an extruding configuration. In the extruding configuration, the bowl 752 may be coupled to a lid 753 (e.g., lid 450 or a variant thereof) that includes a plunger 702. The combination of the bowl 752 and the lid 753 may be referred to herein as a bowl extruding assembly 750. In embodiments, the bowl extruding assembly 750 may be configured to be installed to the micro-puree machine 700 such that the nozzle 760 faces vertically downwards when the bowl extruding assembly 750 is properly installed. The bowl extruding assembly 750 may be assembled to the housing 720 (e.g., the extruding sub-module 723) such that a central axis A of the bowl extruding assembly 750 extends perpendicular to a vertical axis V of the housing 720, as shown. The bowl extruding assembly 750 may include an outlet 760 for extruding processed ingredients from the bowl extruding assembly 750. The micro-puree machine 700 also may include a lever 730 for manually activating a plunger 702 to extrude processed ingredients within the bowl extruding assembly 750 through the outlet 760. While the lever 730 is illustrated on a right side of the machine 700 (from the front view shown in FIG. 5C), the disclosure is not so limited. The lever 730 may be on the left side of, or another location on, the machine 700, and other components of the machine may be rearranged to accommodate the different location of the lever 730. The housing 720 may include electrical, electromagnetic, mechanical and/or electro-mechanical components to translate a pulling down or pushing up of the lever 730 into movement of the plunger 702 within the bowl 752.

Embodiments of the housing 720 of micro-puree machine 700 may house a transmission system that includes a driven shaft 754 for engaging the blade 713, a separate driven shaft 758 for engaging the plunger 702, one or more gearing systems, and one or more position and/or drive motors for moving the driven shaft 754 and the other shaft 758 rotationally and/or axially to process the ingredients in the bowl assembly 750. For example, a drive motor may drive the rotation of the driven shaft 754 and blade (e.g., blade 300) coupled thereto, and a position motor may drive the vertical (e.g., down and up) movement of the driven shaft 754 and a blade. Another motor may drive the second shaft 758 and a plunger (e.g., plunger 454 or 602) attached thereto. In embodiments, the blade 713 may be programmably controlled at the user interface by a computing system to operate at different rotational speeds and moved up and down in different patterns and speeds, and for different periods of time, to make different food items. In embodiments, the plunger 702 in the lid 753 may be programmably controlled at the user interface by a computing system to operate at different rotational speeds and moved up and down in different patterns and speeds, and for different periods of time, to make different food items. Some non-limiting examples of a transmission system and the computing system are shown in described in the '765 patent and in U.S. Pat. No. 11,882,965 to SharkNinja Operating, LLC (the '965 patent), the entire contents of which are hereby incorporated by reference.

In some embodiments of the disclosure, mechanisms are provided, and techniques employed, to automatically lock an ingredient processing bowl into the micro-puree machine during processing and/or extrusion of the ingredients from the bowl, as will now be described.

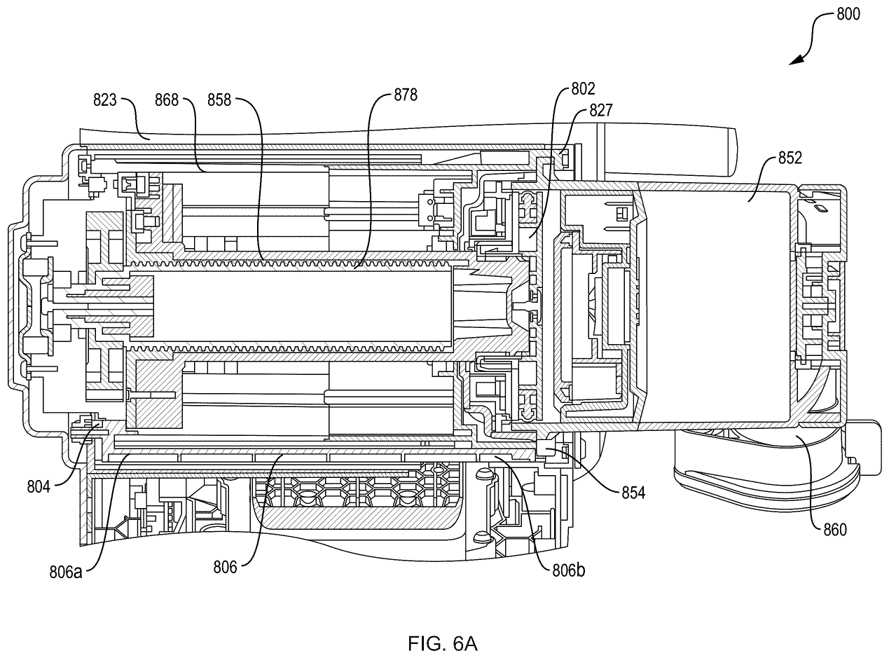

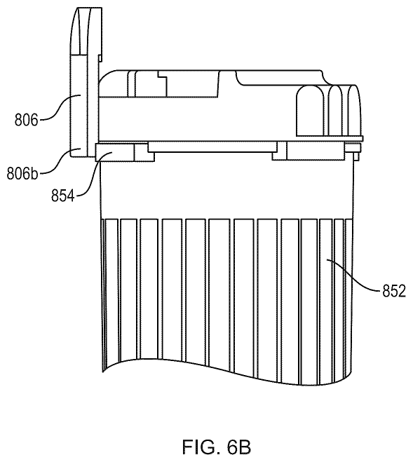

FIGS. 6A and 6B illustrate an automatic bowl lock 800 for locking a bowl 852 (e.g., bowl 752) to a coupling 827 (e.g., coupling 727) during the extrusion process, according to some embodiments of the disclosure. As shown in FIG. 6A, a driven shaft 858 may be moveable relative to a support member 868 within the extruding sub-module 823 (e.g., extruding sub-module 723). The driven shaft 858 may be threadingly or otherwise moveably coupled to a rod 878 extending through the driven shaft 858 such that rotation of the rod 878 (e.g., by operation of a position motor) moves the driven shaft 858 towards and away from the bowl 852. A spring 804 may disposed between a portion of the support member 868 and a locking pin 806 to bias the locking pin 806 towards the bowl 852. The locking pin 806 may be moveable within a set range of travel relative to the support member 868 between a first position and a second position. For example, in a first position of the locking pin 806, the first end 806a of the locking pin 806 may be compressed against the spring 804 while the second end 806b of the locking pin 806 may be positioned away from the projections 854 on the bowl 852. In this position, the locking pin 806 does not prevent the rotation of the bowl 852 as the user installs the bowl 852 into the coupling 827.

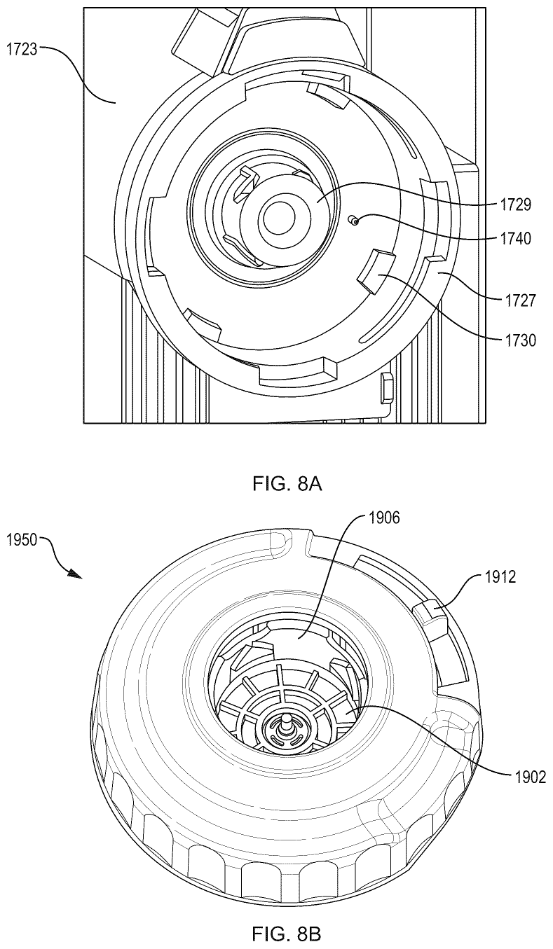

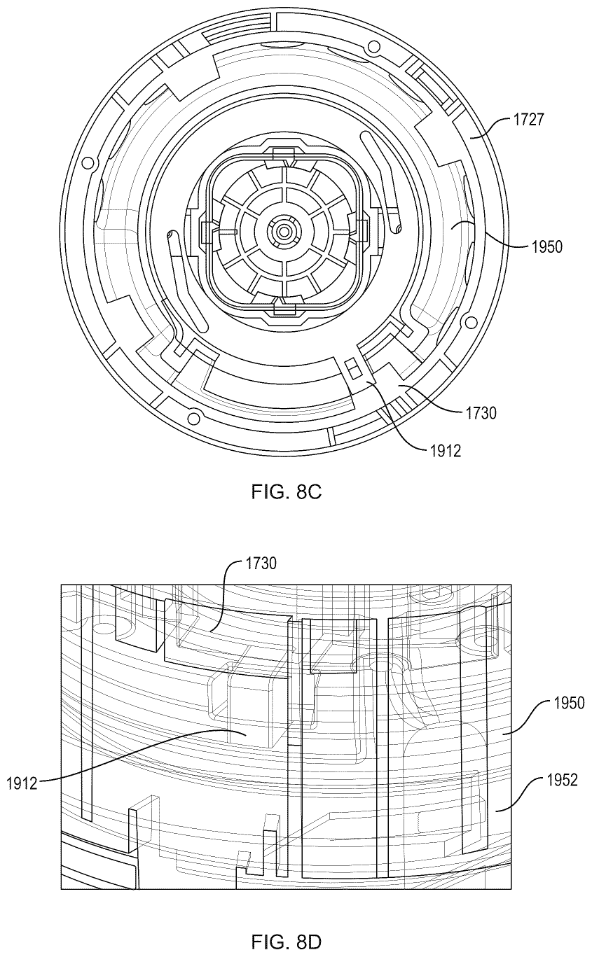

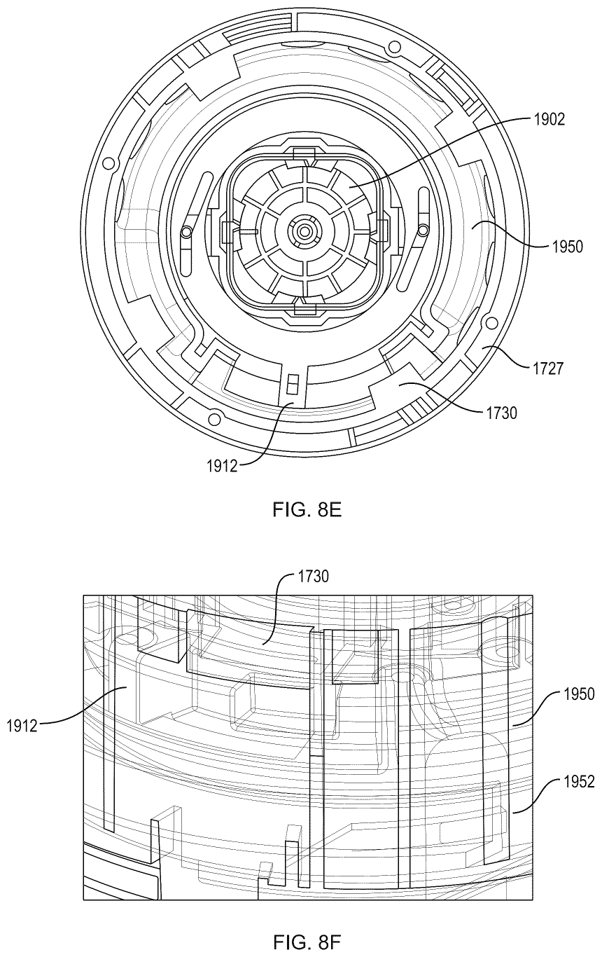

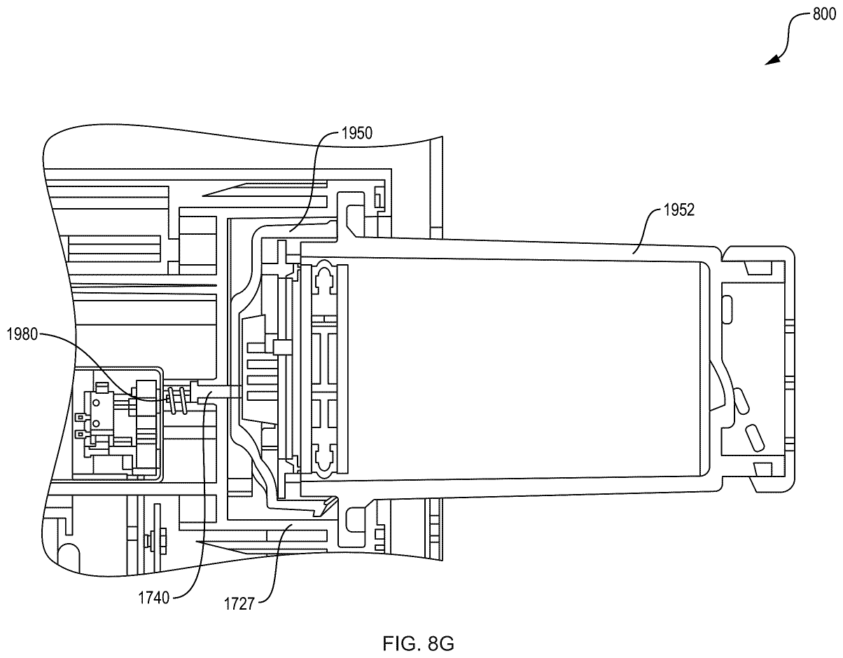

Actuation of the position motor by user (e.g., by selecting the extrusion process at the user interface) may cause the rod 878 to rotate in a first direction, in turn causing translation of the driven shaft 858 toward the bowl 852. This movement of the driven shaft 858 toward the bowl 852 also may move the plunger 802 (e.g., plunger 602) against the processed ingredients inside the bowl 852 to extrude the ingredients through the nozzle 860. At the same time, the first end 806a of the locking pin 806 may be moved by the spring 804 into a second position such that the second end 806b of the locking pin 806 prevents the bowl 852 from being rotated out of the coupling 827—e.g., by blocking rotation of the projections 854 on the bowl 852, as shown in FIG. 8B. This blocking of the rotation of the projections 854 automatically creates a locked state of the bowl 852. Once the extrusion process is finished, the position motor may rotate the threaded rod 878 in a second direction, thus causing the driven shaft 858 to retreat from the bowl 852 and push the locking pin 806 back to the first position. Once the second end 806b of the locking pin 806 is no longer blocking the projections 854 on the bowl 852, the user may be free to rotate the bowl 852 out of the coupling 827 and remove the bowl 852 from the coupling 827. The disclosure also contemplates other suitable mechanisms (e.g., hydraulic mechanisms) for translating the driven shaft 858 towards and away from the bowl 852.

In some embodiments of the disclosure, mechanisms are provided, and techniques employed, to couple a plunger to a driven shaft of a micro-puree machine and/or retain a plunger in a lid of a bowl of processed ingredients to be extruded, as will now be described.

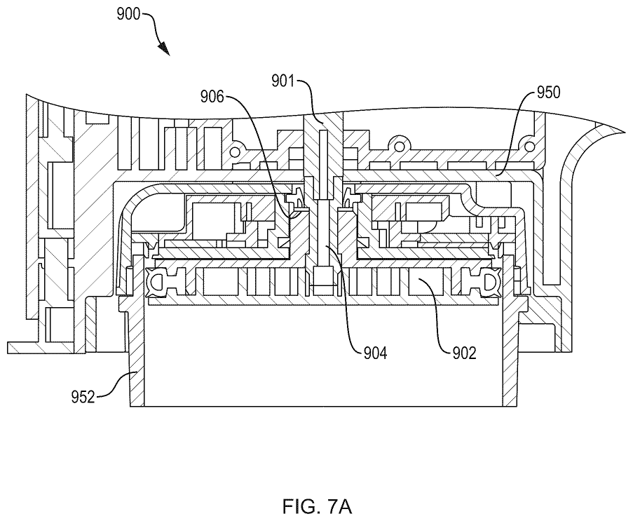

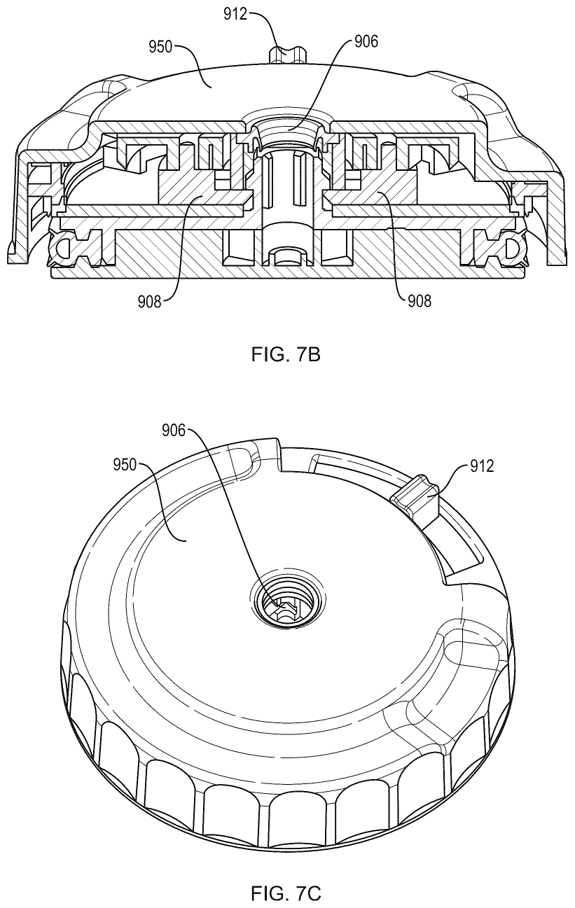

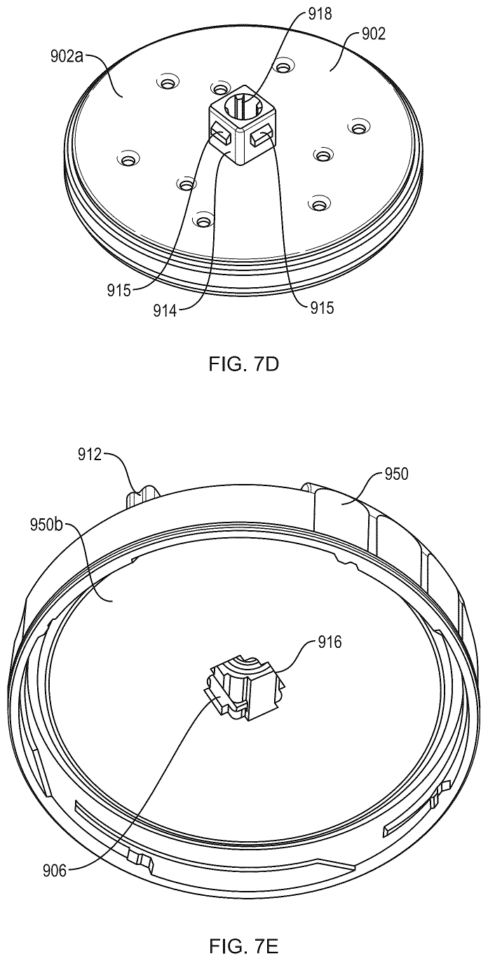

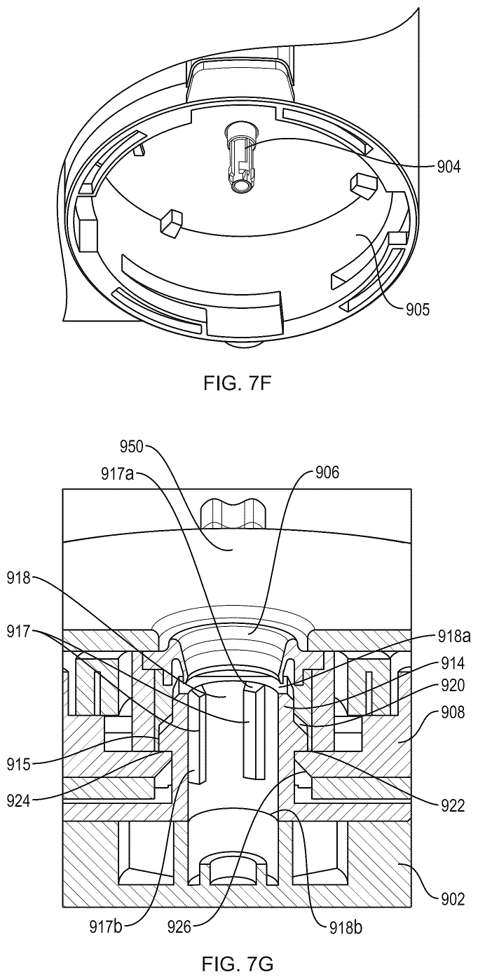

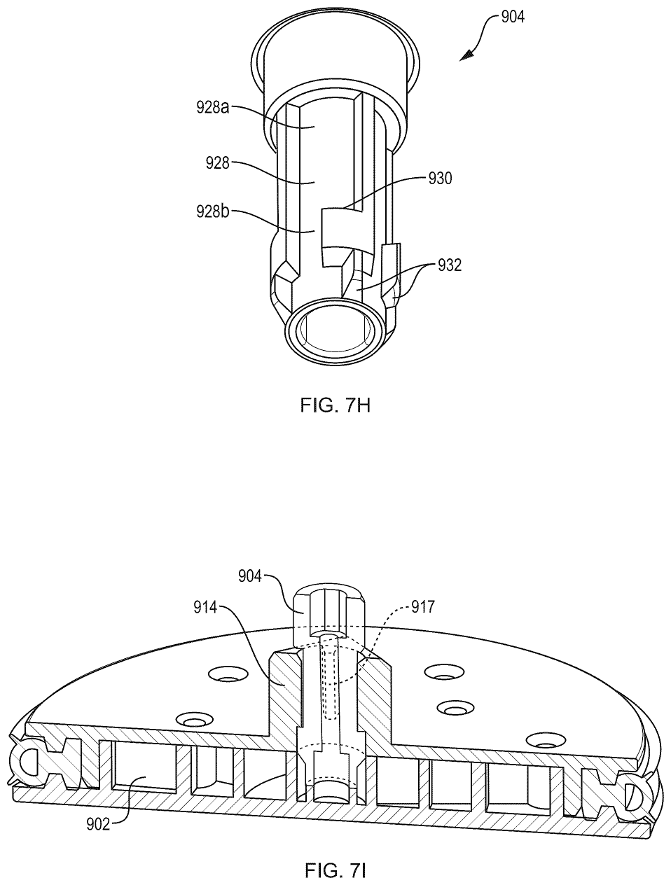

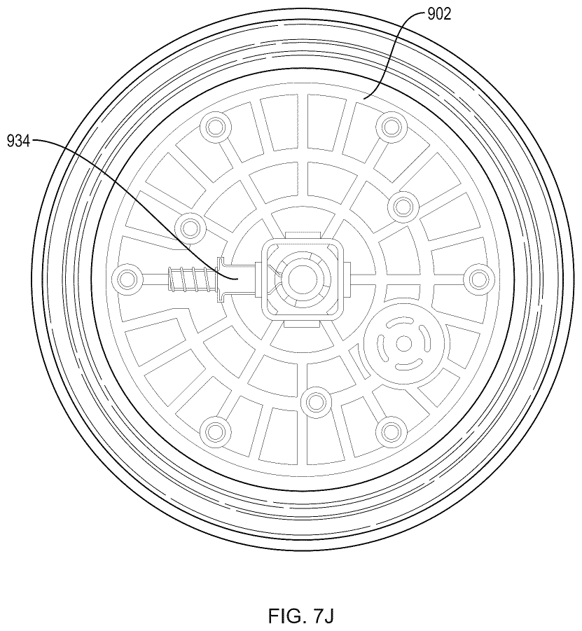

FIGS. 7A-7J illustrate various aspects of a plunger retention assembly 900 according to some embodiments of the disclosure. The plunger retention assembly 900, and parts thereof, may be part of, or coupled to, extruding sub-module 723 of micro-puree machine 700.

As shown in FIG. 7A, the plunger retention assembly 900 generally may include a lid 950 (e.g., lid 450 or 753), a plunger 902 (e.g., plunger 454), and a plunger coupling 904. The lid 950 may be couplable to a bowl 952 (e.g., bowl 752). The combination of the lid 950 and the bowl 952 may form a bowl assembly, such as, for example, bowl assembly 750. The lid 950 may define a central passage 906 through an interior of the lid 950. The plunger coupling 904 may be extendable through the central passage 906 of the lid 950 and may be formed integrally with or coupled to a driven shaft 901 (e.g., driven shaft 250) such that the plunger coupling 904 moves axially with the driven shaft 901.

FIGS. 7B and 7C show detailed views of the lid 950 according to some embodiments of the disclosure. As shown in FIG. 7B, the lid 950 may include at least one retainer 908 moveable within the interior of the lid 950. The at least one retainer 908 may include four retainers 908. However, the disclosure contemplates more or fewer than four retainers 908. The retainers 908 may be biased (e.g., with one or more springs) toward the central passage 906 of the lid 950. The lid 950 may include a release lever 912 operatively coupled to the retainers 908 to move the retainers 908 away from the central passage 906 against the biasing force of the springs. As shown in FIG. 7C, the release lever 912 may be retained on the lid 950 such that it can move rotationally relative to the central passage 906 of the lid 950 within a pre-determined range of motion. When the release lever 912 is in the fully rotated position, the retainers 908 may be positioned at their furthest point of travel away from the central passage 906, allowing the plunger 902 to be installed into or disengaged from the lid 950.

FIGS. 7D and 7E illustrate the engagement between the plunger 902 and the lid 950, according to some embodiments of the disclosure. As shown in FIG. 7D, an upper surface 902a of the plunger 902 may include a central attachment portion 914 extending upward from the upper surface 902a. The attachment portion 914 may define an interior channel 918 for removeably attaching to the plunger coupling 904. An outer surface of the attachment portion 914 may include one or more features for engaging the retainers 908, such as barbs 915. In an embodiment where a cross-sectional shape of the attachment portion 914 is rectangular (e.g., substantially square), as shown, the number of barbs 915 may be four barbs 915. However, the disclosure contemplates more or fewer than four barbs 915 depending on other shapes of the attachment portion, such as triangular or hexagonal.

As shown in FIG. 7E, a bottom surface 950b of the lid 950 may define an opening 916 in communication with the central passage 906 for receiving the attachment portion 914. A shape of the opening 916 may be selected to correspond to a shape of the attachment portion 914 and may be configured to accommodate passage of barbs 915, as shown. The corresponding shape of the attachment portion 914 and the opening 916 may allow the plunger 902 to be installed into the lid 950 in any number of orientations. Moreover, the corresponding shape of the attachment portion 914 and the opening 916 may ensure that the plunger 902 rotates along with the bowl 952 and the lid 950 when the bowl assembly (including bowl 952 and lid 950) is rotated in and out of the coupling 905 (e.g., coupling 500). The coupling 905 may be a bayonet coupling as illustrated in FIG. 7F.

FIG. 7G is a detailed view of the engagement between the retainers 908 and the attachment portion 914 of the plunger 902 according to some embodiments of the disclosure. Each barb 915 may include an upper angled ledge 920 and a lower undercut 922. Each retainer 908 may in turn include an upper retention surface 924 and a lower angled surface 926. When the user inserts the attachment portion 914 of the plunger 902 into the lid 950, the lower angled surface 926 of the retainer 908 may engage with the upper angled ledge 920 of the attachment portion 914 to urge the retainers 908 away from the central passage 906. The outward movement of the retainers 908 may allow the barbs 915 to pass by the retainers 908. The retainers 908 may then move under biasing force toward an engaged position with the attachment portion 914. The undercut 922 may have a generally flat surface that extends radially outward at an approximately 90-degree angle relative to the central passage 906. The upper retention surface 924 may be similarly configured such that it engages with the undercut 922 to retain the plunger 902 in the lid 950 even in the event that significant disengagement forces are applied to the plunger 902. Thus, the lid 950 and the plunger 902 may be held together prior to the attachment portion 914 engaging the plunger coupling 904.

Still referring to FIG. 7G, to engage the plunger coupling 904, the interior channel 918 of the attachment portion 914 may define at least one vertically extending projection 917. The at least one projection 917 may be four projections 917 spaced apart around a circumference of the interior channel 918, as shown. However, the disclosure contemplates more or fewer than four projections 917. A first end 917a of the projections 917 may align with an upper end 918a of the interior channel 918 while a second end 917b of the projections 917 may be spaced apart from a lower end 918b of the channel 918.

FIGS. 7H and 7I illustrate the engagement between the attachment portion 914 of the plunger 902 and the plunger coupling 904 according to some embodiments of the disclosure. As shown in FIG. 7H, the plunger coupling 904 may include a plurality of vertical slots 928 defined on an outer surface of the plunger coupling 904. The plurality of slots 928 may be four slots 928, as shown. However, the disclosure contemplates more or fewer than four slots 928. An upper portion 928a of the slots 928 may have a diameter selected to be wider than a lower portion 928b of the slots 928, such that a shelf 930 is defined between the upper portion 928a and lower portion 928b. The plunger coupling 904 may optionally include a plurality of haptic ridges 932, as further described elsewhere herein. As shown in FIG. 7I, as the user rotates the bowl assembly (including bowl 952 and lid 950) into the coupling 905, the projections 917 on the inner surface of the attachment portion 914 rotate into the upper portion 928a of the slots 928 such that the shelf 930 prevents the plunger 902 from disengaging from the plunger coupling 904. Rotation of the bowl assembly into the coupling 905 also may force the retainers 908 apart such that the plunger 902 can disengage from the lid 950. Disengagement from the lid 950 may allow the plunger 902 to descend through the bowl 952 along with the driven shaft 901 to extrude ingredients from the bowl 952. When the plunger coupling 904 is retracted to the home state after extrusion, the user may rotate the bowl assembly out of the coupling 905. This rotation also rotates the attachment portion 914 of the plunger 902 out of the slots 928 of the plunger coupling 904 and reengages the retainers 908 with the barbs 915. Thus, the plunger 902 now may be fixed to the lid 950 and may be removed when the user removes the bowl assembly from the plunger coupling 904.

FIG. 7J illustrates a sprung haptic plunger 934 according to some embodiments of the disclosure. The haptic plunger 934 may optionally be disposed within the plunger 902 and may be configured to engage the haptic ridges 932 (FIG. 7H) on the plunger coupling 904 when the plunger 902 is rotated into and out of place. The engagement between the haptic plunger 934 and the haptic ridges 932 may give the user haptic feedback that the plunger 902 is properly installed on the plunger coupling 904. The engagement also may provide a resistive force preventing the plunger 902 from rotating relative to the plunger coupling 904 during extrusion. Notably, the prevention of such rotation may be critical to ensure that the plunger 902 realigns with the lid 950 when the plunger 902 is retracted into the lid 950 after extrusion.

In some embodiments of the disclosure, mechanisms are provided, and techniques employed, to prevent a user from coupling a processing bowl assembly to the micro-puree machine when an extrusion plunger is not properly installed in the lid of the bowl assembly, as will now be described.

FIGS. 8A-8G illustrate components of a plunger lockout assembly for use with a micro-puree machine (e.g., micro-puree machine 700), according to some embodiments of the disclosure. The plunger lockout assembly may prevent a user from installing a bowl assembly (e.g., a lid 1950 and a bowl 1952) to the micro puree machine 700 when a plunger 1902 (e.g., plunger 902) is either not installed or is improperly installed to the lid 950. The plunger lockout assembly may also alert a user when the lid 1950 is not assembled to the bowl 1952.

As shown in FIG. 8A, an extruding sub-module 1723 (e.g., extruding sub-module 723) may include a coupling 1727 (e.g., coupling 727) that has an interface 1729 (e.g., interface 729) with a driven shaft (e.g., driven shaft 758). The coupling 1727 may serve as a coupling between the bowl assembly including a lid 1950 and a bowl 1952 and the micro-puree machine 700. An interior surface of the coupling 1727 may include at least one rib 1730 and a pin 1740. The pin 1740 may be operatively coupled to a microswitch, as described further herein. The at least one rib 1730 may be four ribs 1730 spaced equidistantly apart about an interior surface of the coupling 1727, allowing the bowl assembly to be installed to the coupling 1727 in any one of four rotational positions. However, the disclosure contemplates more or fewer than four ribs 1730 and different spacings between the ribs 1730. As used herein, the plunger lockout assembly may primarily comprise the lid 1950 and the coupling 1727.

As shown in FIG. 8B, the lid 1950 may include a release lever 1912 (e.g., release lever 912) operatively coupled to one or more retainers (e.g., retainers 908 to move the retainers 908 away from a central passage 1906 of the lid 1950. The release lever 1912 may be retained on the lid 1950 such that it can move rotationally relative to the central passage 1906 of the lid 1950 within a pre-determined range of motion. When the release lever 1912 is in the fully rotated position, the retainers 908 may be positioned at their furthest point of travel away from the central passage 1906, allowing the plunger 1902 to be installed into or disengaged from the lid 1950. However, when the plunger 1902 is either not installed, or is improperly installed, to the lid 1950, the release lever 1912 may be positioned away from the fully rotated position such that the lever 1912 is blocked by the ribs 1730 from being installed into the coupling 1727.

For example, as shown in FIGS. 8C and 8D, when the plunger 1902 is not installed to the lid 1950, if the user attempts to rotate the bowl assembly into the coupling 1727, the position of the lever 1912 is such that the ribs 1730 block the bowl assembly from being rotated into the coupling 1727 by interfering with movement of the lever 1912 into the coupling 1727. In contrast, as shown in FIGS. 8E and 8F, when an attachment portion (e.g., attachment portion 914) of the plunger 1902 is fully installed to the passage 1906 of the lid 1950, the position of the lever 1912 may be such that the ribs 1730 do not block the lever 1912, and the bowl assembly may be rotated into the coupling 1727. Additionally, as shown in FIG. 8G, when the lid 1950 is assembled to the bowl 1952 and the bowl assembly is rotated into the coupling 1727, the lid 1950 may press against the pin 1740 to activate the microswitch 1980. Thus, if a user were to inadvertently install only the bowl 1952 into the coupling, the microswitch 1980 may not be activated. Activation of the microswitch 1980 may allow running of the extrusion program, either through a software controlled or non-software-controlled circuit. Furthermore, when the plunger 1902 is installed in the bowl 1952, and the user rotates the bowl 1952 within it its permitted degree of rotation to release the bowl 1952 from the coupling 1727, the ribs 1730 may prevent some rotation of the lever 1912 with the bowl 1952. This may cause the retainers 908 to move into their furthest travel position away from the central passage 1906, allowing the plunger 1902 to be released from the lid 1950.

The disclosure contemplates that, in some embodiments, the bowl from which ingredients are processed and/or extruded (e.g., bowl 352, 352′, 352″, 752, 852, 952) can be coupled vertically in an inverted orientation (i.e., downward) on a top or upward-facing surface of the housing (e.g., housing 120, 720) of a micro-puree machine (e.g., micro-puree machine 10, 700) whereby the blade (e.g., blade 300, 713) moves up and then down to creamify, process, and/or mix ingredients in the bowl. The upward-facing surface may face vertically upward or be angled in an upward direction. In some embodiments, the micro-puree machine may be configured to automatically detect a size of the bowl and, in response to the detection, extend the blade a depth and/or travel distance into the bowl based on the detected size of the bowl. This bowl-size detection would advantageously enable the micro-puree machine to process ingredients in different sized containers, such as a single serve container or larger containers.

While the disclosure particularly shows and describes preferred embodiments, those skilled in the art will understand that various changes in form and details may exist without departing from the spirit and scope of the present application as defined by the appended claims. The scope of this present application intends to cover such variations. As such, the foregoing description of embodiments of the present application does not intend to limit the full scope conveyed by the appended claims.

1. A plunger retention assembly for a micro-puree machine, the plunger retention assembly comprising:
a lid coupleable to a bowl, the lid defining a central passage through an interior of the lid;
a plunger coupling extendable through the central passage, the plunger coupling comprising at least one vertical slot defined on an outer surface of the plunger coupling; and
a plunger having an attachment portion insertable through the central passage from a bottom surface of the lid, the attachment portion defining a channel for removeably receiving the plunger coupling, the attachment portion including at least one linear projection extending into the channel, wherein the plunger is locked to the plunger coupling when the attachment portion is rotated relative to the at least one vertical slot of the plunger coupling.

2. The plunger retention assembly of claim 1, wherein:
the lid includes at least one retainer within the interior of the lid;
an outer surface of the attachment portion includes at least one engagement feature for engaging the at least one retainer; and
the at least one retainer is moveable between a first position, in which the at least one retainer engages the engagement feature to retain the plunger in the lid, and a second position, in which the at least one retainer disengages from the engagement feature to allow removal of the plunger from the lid.

3. The plunger retention assembly of claim 2, wherein the at least one retainer comprises four retainers.

4. The plunger retention assembly of claim 2, wherein the at least one retainer is biased toward the central passage.

5. The plunger retention assembly of claim 2, wherein the lid comprises a release lever operatively coupled to the at least one retainer to move the at least one retainer between the first position and the second position.

6. The plunger retention assembly of claim 1, wherein the plunger coupling is configured to move along with a driven shaft of the micro-puree machine.

7. The plunger retention assembly of claim 1, wherein a cross-sectional shape of the attachment portion is rectangular.

8. The plunger retention assembly of claim 2, wherein the at least one engagement feature is four engagement features.

9. The plunger retention assembly of claim 1, wherein a bottom surface of the lid defines an opening in communication with the central passage.

10. The plunger retention assembly of claim 9, wherein a cross-sectional shape of the opening corresponds to a cross-sectional shape of the attachment portion.

11. The plunger retention assembly of claim 10, wherein the cross-sectional shape of the opening is rectangular.

12. The plunger retention assembly of claim 2, wherein the at least one engagement feature has an upper angled ledge for engaging a lower angled surface of the at least one retainer to urge the at least one retainer away from the central passage when the attachment portion is inserted into the central passage.

13. The plunger retention assembly of claim 1, wherein the channel of the attachment portion includes at least one projection for engaging a corresponding slot of the at least one vertical slot.

14. The plunger retention assembly of claim 13, wherein the plunger is locked to the plunger coupling when the at least one projection is rotated into the corresponding slot.

15. The plunger retention assembly of claim 13, wherein the at least one projection is four projections.

16. The plunger retention assembly of claim 13, wherein a diameter of an upper portion of the corresponding slot is selected to be wider than a diameter of a lower portion of the corresponding slot such that a shelf is defined between the upper and lower portions, the shelf configured to prevent disengagement of the at least one projection from the corresponding slot.

17. The plunger retention assembly of claim 1, wherein the plunger and the plunger coupling further comprise corresponding haptic features for providing haptic input to a user that the plunger is properly installed on the plunger coupling.

18. A micro-puree machine, comprising:
a plunger retention assembly including:
a lid coupleable to a bowl, the lid defining a central passage through an interior of the lid;
a plunger coupling extendable through the central passage of the lid, the plunger coupling comprising at least one vertical slot defined on an outer surface of the plunger coupling; and
a plunger having an attachment portion insertable through the central passage from a bottom surface of the lid, the attachment portion defining a channel for removeably receiving the plunger coupling, the attachment portion including at least one linear projection extending into the channel, wherein the plunger is locked to the plunger coupling when the attachment portion is rotated relative to the at least one vertical slot of the plunger coupling.

19. The micro-puree machine of claim 18, wherein:
the lid includes at least one retainer within the interior of the lid;
an outer surface of the attachment portion includes at least one engagement feature for engaging the at least one retainer; and
the at least one retainer is moveable between a first position, in which the at least one retainer engages the engagement feature to retain the plunger in the lid, and a second position, in which the at least one retainer disengages from the engagement feature to allow removal of the plunger from the lid.

20. The micro-puree machine of claim 18, wherein the channel of the attachment portion includes at least one projection for engaging a corresponding slot of the at least one vertical slot.
